(19) United States
(12) Patent Application Publication
(10) Pub. No.: US 2026/0303952 A1
(43) Pub. Date: Oct. 1, 2026

(54) IMAGING APPARATUS AND IMAGE PROCESSING METHOD

(71) Applicant: Panasonic Intellectual Property Management Co., Ltd., Osaka (JP)

(72) Inventor: Shoichi YOKOI, Osaka (JP)

(73) Assignee: Panasonic Intellectual Property Management Co., Ltd., Osaka (JP)

(21) Appl. No.: 19/548,260

(22) Filed: Feb. 24, 2026

(30) Foreign Application Priority Data
Mar. 25, 2025 (JP) 2025-050573

(51) Int. Cl. H04N 23/63; H04N 23/62; H04N 23/667; H04N 23/71; H04N 23/76; H04N 23/88

(52) U.S. Cl. CPC H04N 23/632; H04N 23/62; H04N 23/635; H04N 23/667; H04N 23/71; H04N 23/76; H04N 23/88

(57) ABSTRACT

An imaging apparatus includes an image sensor, a controller and a user interface. The image sensor captures a subject image to generate image data. The controller detects a first region corresponding to a light-emitting body and a second region corresponding to a subject different from the light-emitting body in an image indicated by the image data. The user interface receives a first user operation that selects the first region or the second region in the image. The controller receives a second user operation that sets image quality of the selected region via the user interface, and adjusts image quality of the first region and the second region in the image data in accordance with a result of the setting.

### TECHNICAL FIELD

The present disclosure relates to an imaging apparatus and an image processing method.

### BACKGROUND ART:

An imaging apparatus disclosed in WO 2019/111921 A1 acquires image data of a subject, identifies a color temperature of light from the subject based on the image data, and adjusts white balance of the image data based on the identified color temperature. When the image data includes image data of a specific light-emitting body, this imaging apparatus suppresses saturation of the adjusted image data based on the identified color temperature.

### SUMMARY

The present disclosure provides an imaging apparatus, an image processing method, and a program that make it possible to capture an image having natural color tones.

An imaging apparatus according to one aspect of the present disclosure includes: an image sensor that captures a subject image to generate image data; a controller that detects a first region corresponding to a light-emitting body and a second region corresponding to a subject different from the light-emitting body in an image indicated by the image data; and a user interface that receives a first user operation that selects the first region or the second region in the image. The controller receives a second user operation that sets image quality of the selected region via the user interface, and adjusts image quality of the first region and the second region in the image data in accordance with a result of the setting.

A method according to one aspect of the present disclosure is an image processing method executed by a controller of an imaging apparatus. The method includes:
acquiring image data generated by capturing a subject image;
detecting a first region corresponding to a light-emitting body and a second region corresponding to a subject different from the light-emitting body in an image indicated by the image data;
receiving an input of a first user operation that selects the first region or the second region in the image;
receiving a second user operation that sets image quality of the selected region; and
adjusting image quality of the first region and the second region in the image data in accordance with a result of the setting.

A non-transitory computer-readable storage medium according to one aspect of the present disclosure stores a program for causing a processor to execute the image processing method according to the aspect described above.

According to the present disclosure, it is possible to capture an image having natural color tones.

### BRIEF DESCRIPTION OF THE DRAWINGS

FIG. 1 is a block diagram illustrating a configuration example of a digital camera according to the first embodiment.

FIG. 2 is a schematic diagram illustrating a rear side of the digital camera according to the first embodiment.

FIG. 3 is a schematic diagram illustrating an example of a shooting scene.

FIG. 4 is a flowchart illustrating a white balance setting operation performed by the digital camera according to the first embodiment.

FIG. 5 is a flowchart for explaining details of the white balance setting processing shown in FIG. 4.

FIGS. 6A to 6C are diagrams illustrating an example of a region selection screen according to the first embodiment.

FIGS. 7A and 7B are diagrams for explaining a white set registration mode.

FIG. 8 is a flowchart illustrating a white balance application operation performed by the digital camera according to the first embodiment.

FIG. 9 is a flowchart illustrating gradation correction processing according to the second embodiment.

FIGS. 10A to 10C are diagrams illustrating a gradation setting screen according to the second embodiment.

FIG. 11 is a graph illustrating an example of tone curves set for each region by the gradation correction processing.

FIG. 12 is a flowchart illustrating exposure correction processing according to the third embodiment.

FIGS. 13A to 13C are diagrams illustrating an exposure setting screen according to the third embodiment.

FIG. 14 is a flowchart illustrating an exposure correction application operation performed by the digital camera according to the third embodiment.

### DETAILED DESCRIPTION

Hereinafter, embodiments of the present disclosure will be described with reference to the drawings as appropriate. However, in the detailed description, unnecessary parts in descriptions of the conventional technique and the substantially same configuration may be omitted. The following description and the accompanying drawings are provided so that those skilled in the art can fully understand the present disclosure, and not intended to limit the subject matter of the claims.

### 1. First Embodiment

### 1-1. Configuration

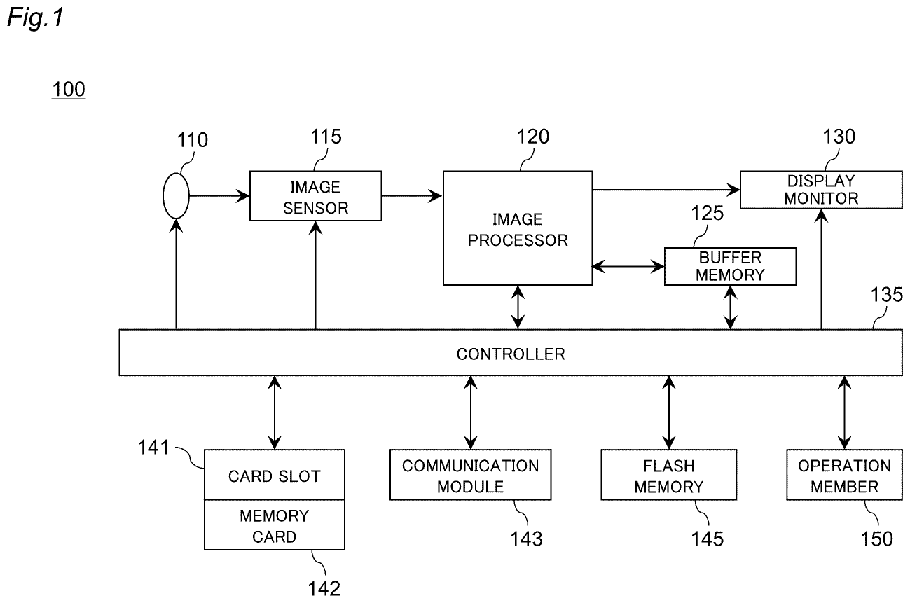

FIG. 1 is a block diagram illustrating a configuration example of a digital camera 100 according to the first embodiment of the present disclosure. The digital camera 100 captures a subject image to generate image data. The image data generated by the digital camera 100 includes moving image data and still image data.

The digital camera 100 captures a subject image formed via an optical system 110 with an image sensor 115 to generate original image data (RAW data). An image processor 120 performs various types of processing on the RAW data generated by the image sensor 115 to generate image data. A controller 135 records the image data generated by the image processor 120 in a flash memory 145 or a memory card 142 inserted into a card slot 141. The controller 135 can also display (reproduce) the image data recorded in the flash memory 145 or the memory card 142 on a display monitor 130 in accordance with a user operation performed on an operation member 150.

The optical system 110 includes a focus lens, a zoom lens, an optical image stabilization (OIS) lens, a diaphragm, a shutter, and the like. Various lenses included in the optical system 110 may be constituted with any number of lenses or any number of groups.

The image sensor 115 captures a subject image formed through the optical system 110 to generate RAW data. The image sensor 115 generates image data of a new frame at a predetermined frame rate (e.g., 30 frames/second). The timing of RAW data generation and electronic shutter operation in the image sensor 115 are controlled by the controller 135.

The image processor 120 performs various kinds of processing on the RAW data output from the image sensor 115 to generate image data. In addition, the image processor 120 performs various kinds of processing on the image data read from the memory card 142 to generate an image to be displayed on the display monitor 130. Examples of the various kinds of processing include, but are not limited to, white balance correction, gamma correction, YC conversion processing, electronic zoom processing, compression processing, decompression processing, image processing using a lookup table (LUT), and the like. The image processor 120 may be constituted with a hard-wired electronic circuit or a microcomputer using a program.

The display monitor 130 is a display device such as a liquid crystal display or an organic EL display configured to display information. For example, the display monitor 130 displays an image based on the image data processed by the image processor 120. In addition, the display monitor 130 displays a menu screen for the user to confirm setting of the digital camera 100.

The controller 135 integrally controls the entire operation of the digital camera 100. The controller 135 may include a processor configured to implement a predetermined function by executing a program. For example, the controller 135 includes a circuit such as a CPU, an MPU, or an FPGA. Although not illustrated, the controller 135 includes a ROM. The ROM stores various programs like autofocus control (AF control) to be executed by the controller 135. In addition, the controller 135 incorporates a RAM (not shown) that functions as a work area of the CPU.

A buffer memory 125 is a recording medium that functions as a work memory of the image processor 120 and the controller 135. The buffer memory 125 is implemented by a DRAM, or the like.

The memory card 142 is detachably inserted into the card slot 141. The card slot 141 can be electrically and mechanically connected to the memory card 142. The memory card 142 is an external memory including a recording element such as a flash memory therein. The memory card 142 can store data such as an LUT and image data generated by the image processor 120.

A communication module 143 is a communication circuit that performs wireless or wired communication in accordance with a communication standard. For example, the digital camera 100 can communicate with a communication network such as the Internet and/or another equipment equipped with a Wi-Fi module via the communication module 143. The digital camera 100 may directly communicate with another equipment via the communication module 143 or may communicate via an access point.

The flash memory 145 is a non-volatile recording medium. The flash memory 145 can store various types of data such as image data.

The operation member 150 is a general term of a user interface such as a hardware key and a software key of the digital camera 100 and receives operation by the user. The operation member 150 includes, for example, a button, a mode dial, a touch panel, and a switch. If operation by the user is received, the operation member 150 transmits an operation signal according to the user operation to the controller 135.

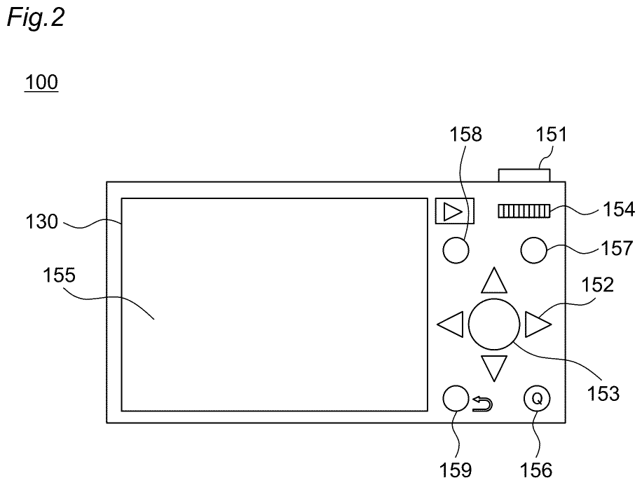

FIG. 2 shows, as an example of the operation member 150, a release button 151, cursor buttons 152, an enter button 153, a dial 154, a touch panel 155, and a plurality of function buttons (Fn buttons) 156 to 159.

The release button 151 is a two-stage press button. When the release button 151 is half-pressed by the user, the controller 135 executes autofocus control (AF control), auto exposure control (AE control), and the like. When the release button 151 is fully pressed by the user, the controller 135 records, as a recorded image, image data captured in response to the pressing operation in a memory card 142 or the like.

The cursor buttons 152 include push buttons corresponding to up, down, left, and right directions, and, when pressed by a user, can move a selection area, a cursor, and the like displayed on the display monitor 130. The enter button 153 is a press button. When the enter button 153 is pressed by the user while the digital camera 100 is in an image capturing mode or a reproduction mode, the controller 135 may display a menu screen on the display monitor 130. The menu screen is a screen for setting various conditions for shooting/reproduction.

The dial 154 is a rotary operation member. By rotating the dial 154, a selection area, a cursor, and the like displayed on the display monitor 130 can be moved. The dial 154 may be usable for setting various modes of the digital camera 100.

Each Fn button is a press button to which a specific function of the digital camera 100 is assigned. In the present embodiment, the Fn buttons include a Q button 156, a DISPLAY (DISP) button 157, a SET button 158, and a return button 159. Other functions may be assigned to the Fn buttons.

In the operation member 150, operations using the various buttons as described above may be configured to be executable not only by physical buttons but also, for example, by displaying virtual buttons on the display monitor 130 and receiving touch operations via the touch panel 155.

### 1-2. Operation

### 1-2-1. Shooting Scene

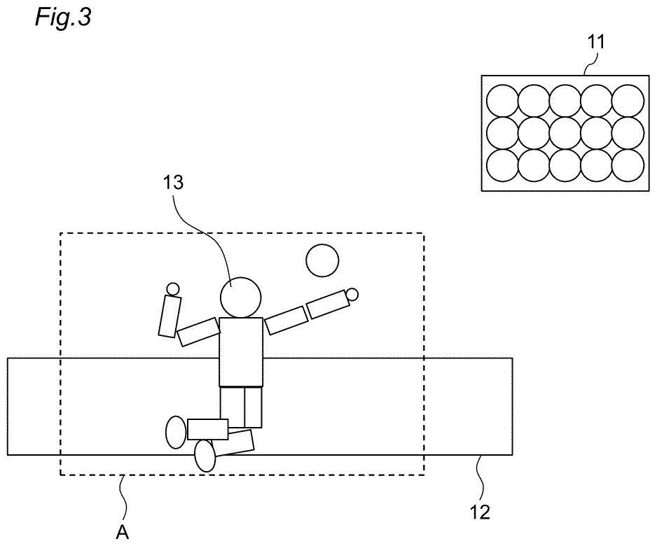

Operations of the digital camera 100 configured as described above will be explained. In the following, operations performed during shooting by the digital camera 100 will be described. Shooting operations of the digital camera 100 are performed, for example, in a sports shooting scene indoors or outdoors as illustrated in FIG. 3.

The shooting scene illustrated in FIG. 3 includes a floodlight 11, an LED board 12, and players 13. The floodlight 11 is a light source that emits light to illuminate a venue. The floodlight 11 includes, for example, a mercury lamp, an LED (Light-Emitting Diode), and the like.

The LED board 12 is a display that displays information using LEDs arranged two-dimensionally. For example, advertisements are displayed on the LED board 12. The LED board 12 is an example of a light-emitting body according to the present disclosure. However, the light-emitting body is not limited to the LED board 12 including LEDs, and may include display devices such as liquid crystal displays and organic EL displays capable of displaying information.

In the example of FIG. 3, the digital camera 100 captures a subject image within an angle of view A to generate image data. In FIG. 3, the angle of view A is indicated by a broken line. A captured image indicated by the generated image data includes a self-luminous region (or light-emitting region) corresponding to the LED board 12 and an ambient-light region corresponding to subjects other than the LED board 12. The LED board 12 is an example of a light-emitting body. In the ambient-light region, ambient light from the floodlight 11 is the dominant light source.

In an image including an ambient-light region and a self-luminous region corresponding to the LED board 12, when white balance is adjusted such that a white subject located in the ambient-light region is rendered white, an image displayed on the LED board 12 that is intended to appear white may result in a color shift, causing the image to become tinted. Conversely, when white balance is adjusted such that an image displayed on the LED board 12 that is intended to appear white is rendered white, a white subject located in the ambient-light region may result in a color shift and become tinted.

The digital camera 100 according to the present embodiment can solve the above-described problem by individually adjusting white balance of a region selected by a user operation from among the ambient-light region and the self-luminous region, or of both regions. Hereinafter, operations of such a digital camera 100 will be described in detail.

### 1-2-2. White Balance Setting

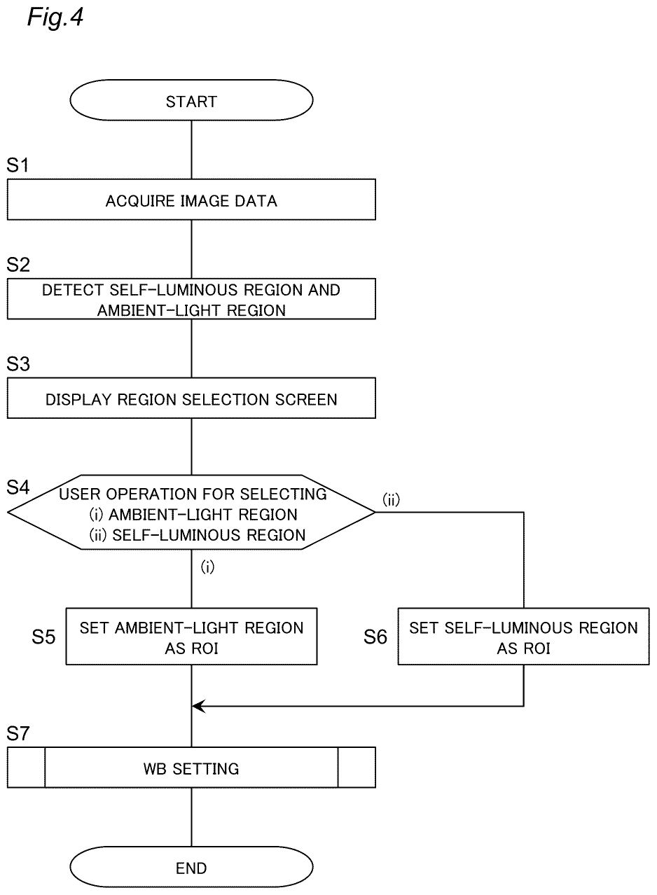

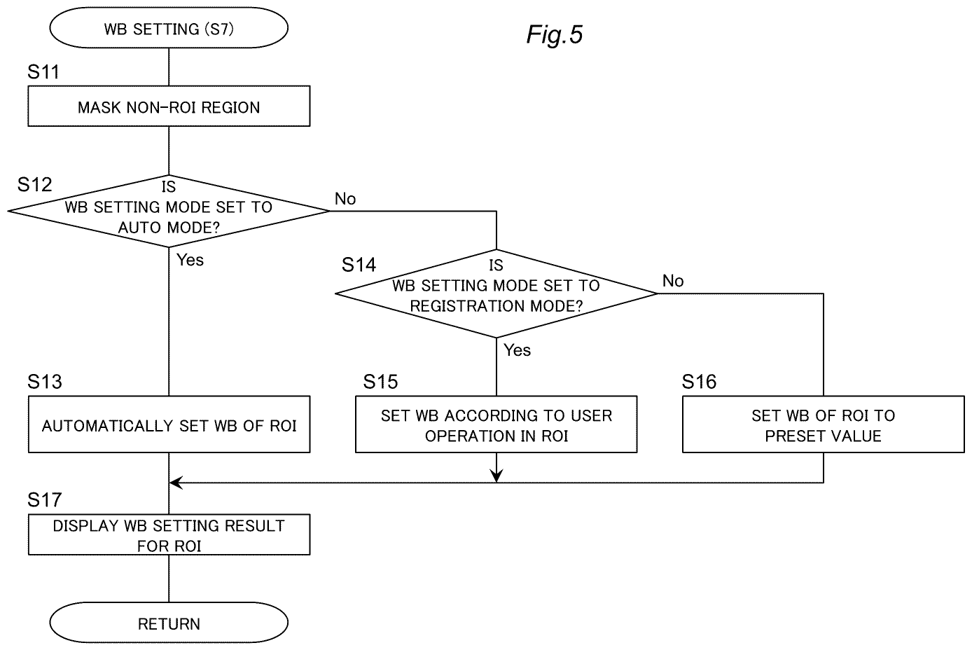

FIG. 4 is a flowchart illustrating a white balance (WB) setting operation performed by the digital camera 100 according to the present embodiment. FIG. 5 is a flowchart for explaining details of WB setting processing (S7) shown in FIG. 4. The flow of FIG. 4 is repeatedly executed, for example, at a predetermined cycle.

In FIG. 4, first, the controller 135 controls an imaging operation of the image sensor 115 to acquire image data (S1). For example, in accordance with control by the controller 135, the image sensor 115 captures a subject image formed via the optical system 110 to generate RAW data, and outputs the RAW data to the image processor 120.

For example, the image processor 120 executes processing for detecting a self-luminous region and an ambient-light region (hereinafter, also referred to as “region segmentation processing”) using a trained model obtained by machine learning (S2). The trained model is implemented by, for example, a neural network.

The trained model is generated by machine learning so as to detect a self-luminous region and an ambient-light region in an image, for example. The trained model may be generated by supervised learning using a training dataset (training data). The training data may include image data and ground-truth data in which each pixel of the image data is labeled to indicate a self-luminous region or an ambient-light region. The trained model may be generated in a training device that is an information processing apparatus, and may be stored in a storage medium such as a flash memory 145, an internal memory in the image processor 120, or the like via a memory card 142, a communication module 143, or the like.

The model for the trained model is not limited to a neural network, and may be another machine learning model for image recognition. The region segmentation processing may be performed by rule-based image recognition processing such as clustering, texture analysis, or template matching.

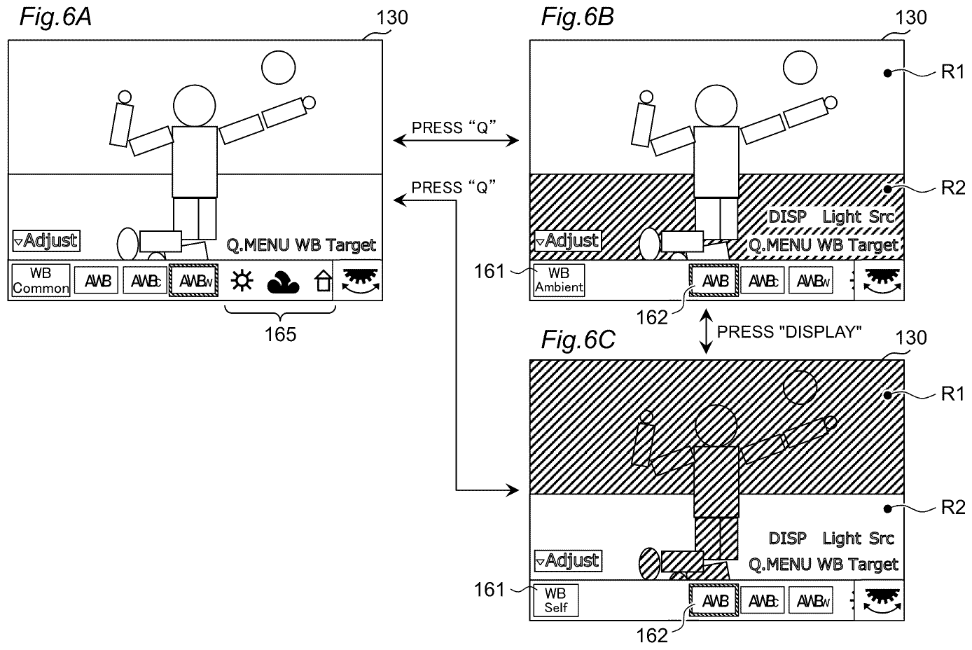

The controller 135 causes a display monitor 130 to display a region selection screen as illustrated in FIG. 6A (S3). On the region selection screen, for example, an image indicated by the image data acquired in step S1 and various setting buttons are displayed.

At the time of image display in step S3, for example, an initial value of white balance for the entire image is determined by a conventional auto white balance (AWB) function. Alternatively, initial values of white balance for each of the ambient-light region and the self-luminous region may be determined in advance. Once the white balance of the ambient-light region and/or the self-luminous region is determined in step S7, in the second and subsequent executions of the processing of FIG. 4, the white balance of the ambient-light region and/or the self-luminous region is maintained at the determined value until it is reset in step S7.

Next, the controller 135 receives an input of a user operation for selecting the self-luminous region or the ambient-light region (S4), and sets the selected region as a region of interest (hereinafter, referred to as an ROI) (S5 and S6). The ROI is a region to be subjected to WB setting. For example, while the region selection screen is displayed, the user can input a user operation for selecting the self-luminous region or the ambient-light region by using the Q button 156 and the DISP button 157.

Next, the controller 135 executes WB setting S7 for the ROI.

As shown in FIG. 5, in WB setting S7, the controller 135 performs mask processing (S11) that lowers visibility of a non-region-of-interest region (hereinafter, referred to as a non-ROI region) of the image, which is a region other than the ROI (a region not selected in S4), to a level lower than that of the ROI. The visibility refers to visibility related to a subject. As a result of the mask processing, visibility of a display appearance of the ROI becomes higher than visibility of a display appearance of the non-ROI region.

An example of the mask processing will be described with reference to FIG. 6.

When shooting is performed, a through image (or a live view image) is displayed on the display monitor 130, as shown in FIG. 6A. When the Q button 156 is pressed while the screen shown in FIG. 6A is displayed, the controller 135 transitions the screen to a region selection screen shown in FIG. 6B or FIG. 6C.

The region selection screen shown in FIG. 6B shows a display screen in a state where the ambient-light region R1 is selected in step S4 of FIG. 4. That is, in step S5, the ROI is set to the ambient-light region R1. In FIG. 6B, a zebra pattern (hatching) is applied as a mask to the self-luminous region R2, which is a non-ROI region. A through image is displayed in the ambient-light region R1. As a result, visibility of the self-luminous region R2 is lower than visibility of the ambient-light region R1. On the region selection screen shown in FIG. 6B, an ROI indicator 161 indicating that the screen is for setting white balance of the ambient-light region R1 is displayed.

When the DISP button 157 is pressed while the region selection screen shown in FIG. 6B, in which the ROI is the ambient-light region R1, is displayed, the screen transitions to the region selection screen shown in FIG. 6C. The region selection screen shown in FIG. 6C shows a display screen in a state where the self-luminous region R2 is selected in step S4 of FIG. 4. That is, in step S5, the ROI is set to the self-luminous region R2. On the ROI indicator 161 of the region selection screen shown in FIG. 6C, it is indicated that the screen is for setting white balance of the self-luminous region R2.

As described above, the region selection screens shown in FIG. 6B and FIG. 6C can be switched from one to the other by using the DISP button 157. That is, the region selection operation in step S4 can be realized by the DISP button 157.

The mask processing may be any processing that lowers visibility of a masked region to a level lower than that of an unmasked region, and the mask applied by the mask processing is not limited to hatching. For example, the mask may be an image pattern such as a mesh pattern other than hatching, or various textures. In addition, or alternatively, various image processing operations such as reducing contrast, reducing resolution, blurring, or changing color may be applied to the non-ROI region in the mask processing. By the mask processing, a subject in the non-ROI region may become less visible than a subject in the ROI, or may become completely invisible.

Returning to FIG. 5, after performing mask processing on the non-ROI region, the controller 135 sets white balance in accordance with a mode selected by a user operation (S12 to S16).

For example, when the WB setting mode is an auto mode (AWB) (Yes in S12), the controller 135 automatically sets white balance of the ROI (S13). In the examples of FIG. 6B and FIG. 6C, an AWB icon 162 is selected, and the WB setting mode is set to the auto mode. The WB setting mode can be selected by a user operation using the cursor buttons 152, a touch on the touch panel 155, the dial 154, or the like.

In step S13, white balance can be adjusted more accurately than in a conventional technique that sets white balance for an entire image, since image information of only the ROI excluding the non-ROI region is used.

When the WB setting mode is a registration mode in which a white set can be registered by a user operation, rather than the auto mode (Yes in S14), the controller 135 sets white balance in accordance with a user operation for selecting a white subject in the ROI (S15).

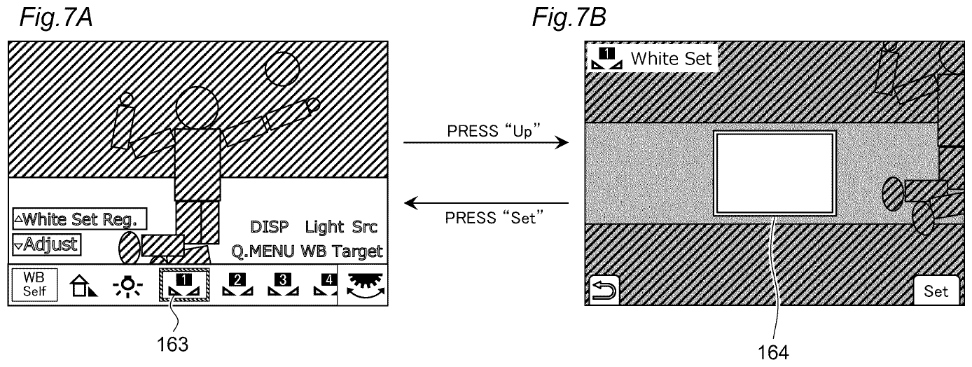

FIGS. 7A and 7B are diagrams for explaining a white set registration mode. FIG. 7A shows, similarly to FIG. 6C, a region selection screen in a state where the self-luminous region R2 is selected in step S4 of FIG. 4. On the region selection screen shown in FIG. 7A, a registration mode icon 163 for shifting to the white set registration mode is displayed. When the registration mode icon 163 is selected, and the up button of the cursor buttons 152 is pressed while the screen shown in FIG. 7A is displayed, the screen transitions to a white set registration screen shown in FIG. 7B.

On the white set registration screen illustrated in FIG. 7B, when the screen shown in FIG. 7B is displayed and the enter button 153 is pressed in a state where a white subject is captured within a frame 164 at the center of the screen, white balance is set so that an image within the frame 164 is displayed in white, and the screen returns to the region selection screen shown in FIG. 7A.

Returning to FIG. 5, when the WB setting mode is neither the auto mode nor the registration mode (No in S14), the controller 135 sets white balance of the ROI to a preset value in accordance with a user operation (S16).

A preset value is a white balance setting value prepared in advance so as to be suitable for a typical light source. A plurality of preset values may be prepared in advance and stored in the flash memory 145. Such preset values of white balance include, for example, a value suitable for outdoor shooting in fine weather, a value suitable for outdoor shooting in cloudy weather, a value suitable for shooting in shade in fine weather, a value suitable for shooting under an incandescent lamp, and a value suitable for flash shooting. For example, a preset value can be set by a user operation of selecting one of preset icons 165 displayed in FIG. 6A.

After completion of white balance setting (S13, S15, or S16), the controller 135 applies the set white balance values to an image of the ROI on the region selection screen shown in FIG. 6B or FIG. 6C (S17). On this screen, the non-ROI region remains masked. As compared with a case where the non-ROI region is not masked and visibility of the ROI and the non-ROI region is similar, the user can more easily visually recognize a result of the white balance setting in the ROI. For example, the user can more easily confirm whether a subject that should appear white in the ROI is displayed in white.

The processing shown in FIG. 4 can be repeatedly executed. For example, in a first execution, the ambient-light region R1 is set as the ROI (S5), and white balance of the ambient-light region R1 is set (S7), and in a subsequent execution, the self-luminous region R2 is set as the ROI (S6), and white balance of the self-luminous region R2 is set (S7).

As described above, the digital camera 100 according to the present embodiment can individually adjust white balance of an ROI selected by a user operation from among the ambient-light region and the self-luminous region, separately from a non-ROI region. As a result, white balance of the ambient-light region and white balance of the self-luminous region can each be appropriately adjusted. Therefore, it is possible to prevent a white subject located in the ambient-light region or the self-luminous region from becoming tinted due to collectively setting white balance for an entire image, and to capture an image having natural color tones.

### 1-2-3. Application of White Balance

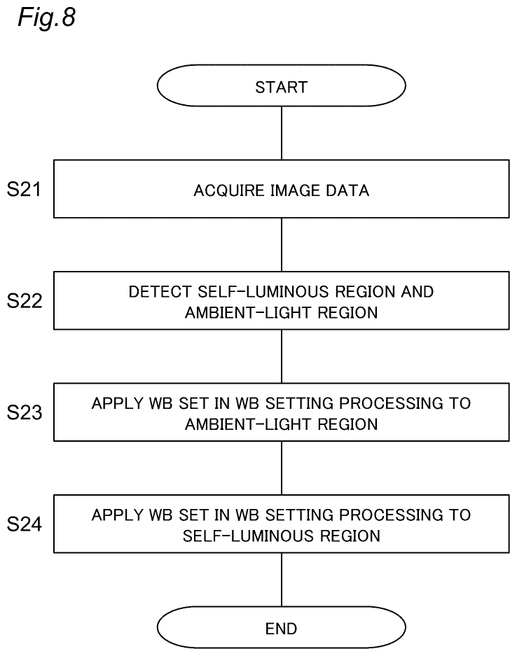

Next, an operation for applying white balance set in the processing of FIG. 4 to a captured image will be described with reference to FIG. 8. The flow of FIG. 8 is repeatedly executed, for example, at a predetermined frame cycle.

In FIG. 8, first, the controller 135 controls an imaging operation of the image sensor 115 to acquire image data (S21). The image processor 120 detects a self-luminous region and an ambient-light region in an image indicated by the acquired image data (S22).

Next, the controller 135 applies the WB set for the ambient-light region in the WB setting processing to the ambient-light region detected in step S22 (S23), and applies the WB set for the self-luminous region in the WB setting processing to the self-luminous region detected in step S22 (S24). Step S24 may be executed before step S23, or both may be executed simultaneously.

### 1-3. Effects

As described above, the digital camera 100 according to the present embodiment includes an image sensor 115, a controller 135, and an operation member 150. The image sensor 115 captures a subject image to generate image data. The controller 135 detects, in an image indicated by the image data, a self-luminous region corresponding to a light-emitting body and an ambient-light region corresponding to a subject different from the light-emitting body. The operation member 150, which is an example of a user interface, is configured to receive a first user operation that selects the self-luminous region or the ambient-light region in the image. The controller 135 receives a second user operation that sets image quality of the selected region selected via the operation member 150, and adjusts image quality of the self-luminous region and the ambient-light region in the image data in accordance with a result of the setting. In the present embodiment, the second user operation sets the image quality by adjusting white balance of the selected region.

The digital camera 100 according to the present embodiment can individually adjust white balance of an ROI selected by the first user operation from among the ambient-light region and the self-luminous region, separately from a non-ROI region. As a result, it is possible to capture an image having natural color tones or color tones that match user preferences.

The digital camera 100 may further include a display monitor 130 that displays images. The controller 135 displays the self-luminous region and the ambient-light region on the display monitor 130, and receives, via the operation member 150, the first user operation. Accordingly, the user can adjust image quality while viewing the image displayed on the display monitor 130.

The controller 135 may cause the display monitor 130 to display a selected region and a non-selected region, from among the self-luminous region and the ambient-light region, in display appearances different from each other. For example, the controller may cause the display to display the selected region in a first display appearance, and may cause the display to display a non-selected region not selected from the first region and the second region in a second display appearance different from the first display appearance. In the present embodiment, a display appearance of the selected region has higher visibility than a display appearance of the non-selected region. As a result, compared with a case in which visibility of the selected region and the non-selected region is similar, a user can more easily visually recognize a result of image quality adjustment in the selected region. For example, the user can more easily confirm whether a subject that should appear white in the selected region is displayed in white.

### 2. Second Embodiment

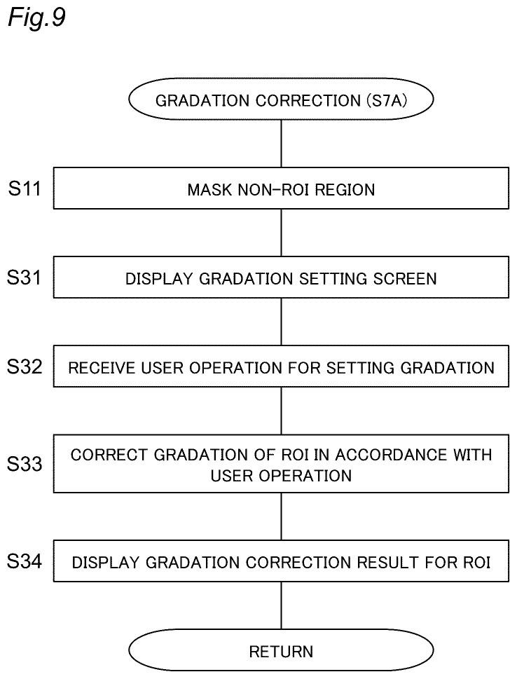

In the first embodiment, an example in which WB setting S7 is performed as an example of image quality setting processing for an ROI has been described. However, the image quality setting is not limited thereto. In the second embodiment, an example in which gradation correction processing is performed as the image quality setting will be described. That is, in the second embodiment, the controller 135 executes the processing of S1 to S6 in FIG. 4 in the same manner as in the first embodiment 1, and executes gradation correction processing S7A shown in FIG. 9 instead of the WB setting S7 of FIG. 4.

FIG. 9 is a flowchart illustrating gradation correction processing S7A. In FIG. 9, first, the controller 135 performs mask processing (S11) that lowers visibility of a non-ROI region relative to an ROI. The mask processing in the present embodiment is the same as the mask processing of the first embodiment shown in FIG. 5.

The controller 135 causes the display monitor 130 to display a gradation setting screen (S31), and receives, via the operation member 150, an input of a user operation for setting gradation (S32). In accordance with the received user operation, the controller 135 corrects gradation of the ROI (S33). The controller 135 causes the display monitor 130 to display a captured image to which the gradation correction has been applied (S34).

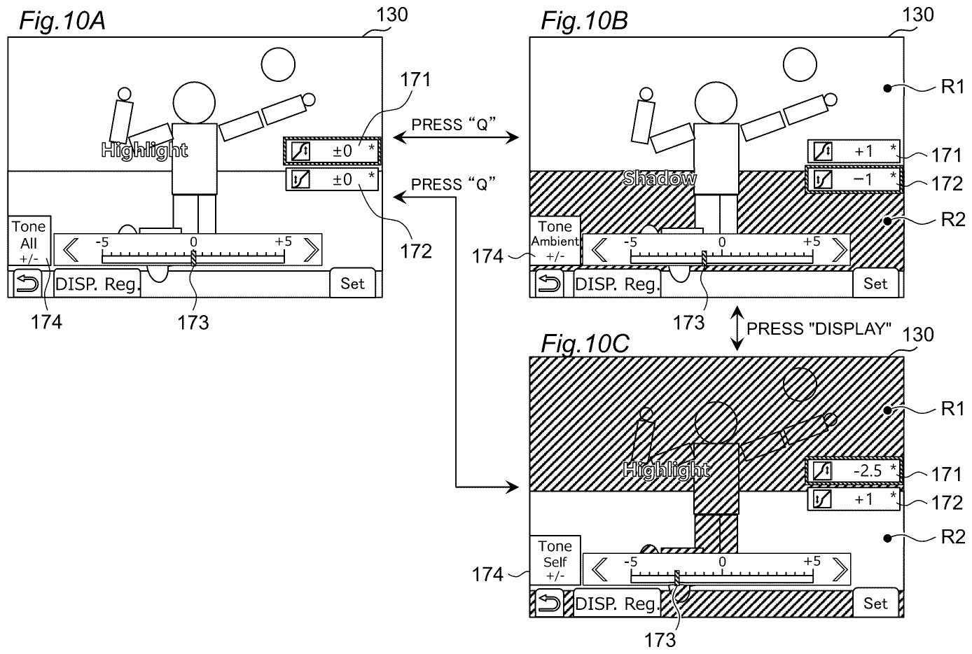

FIGS. 10A, 10B and 10C are diagrams illustrating a gradation setting screen. The gradation setting screen is superimposed on a region selection screen. As in the region selection screen of the first embodiment shown in FIG. 6, in the gradation setting screen of FIGS. 10A and/or 10B, the user can input a user operation for selecting a self-luminous region or an ambient-light region by using the Q button 156 and the DISP button 157.

When shooting is performed, a through image is displayed on the display monitor 130, as shown in FIG. 10A. In FIG. 10A, gradation correction can be performed for an entire image.

The gradation setting screen displays, as an example, a highlight icon 171 for shifting to a highlight setting mode for setting gradation of a bright portion, and a shadow icon 172 for shifting to a shadow setting mode for setting gradation of a dark portion. In the highlight setting mode and the shadow setting mode, a user can set gradation of the bright portion and the dark portion, respectively, by using a slide bar 173. Respective setting values of gradation of the bright portion and the dark portion are displayed on the highlight icon 171 and the shadow icon 172.

For example, a bright portion is one or more pixels having pixel values equal to or greater than a first predetermined value, and a dark portion is one or more pixels having pixel values less than a second predetermined value. The first predetermined value and the second predetermined value may be the same or may be different.

When the Q button 156 is pressed while the screen shown in FIG. 10A is displayed, the controller 135 transitions the screen to a per-region gradation setting screen shown in FIG. 10B or FIG. 10C.

The region selection screen shown in FIG. 10B shows a display screen in a state where the ambient-light region R1 is selected. As in the first embodiment, mask processing lowers visibility of the self-luminous region R2 relative to the ambient-light region R1. The region selection screen shown in FIG. 10B displays a ROI indicator 174 indicating that the screen is used to set gradation of the ambient-light region R1.

When the DISP button 157 is pressed while the region selection screen shown in FIG. 10B is displayed, the screen transitions to the region selection screen shown in FIG. 10C. In this manner, the region selection screens of FIG. 10B and FIG. 10C can be switched from one to the other by using the DISP button 157.

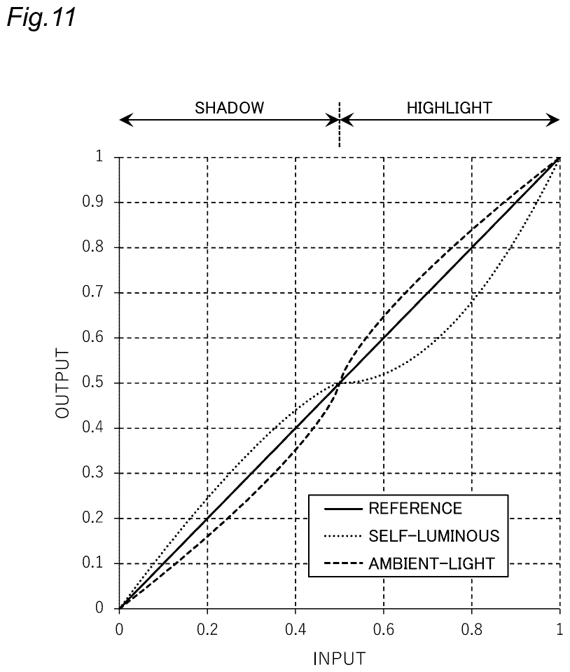

FIG. 11 is a graph showing an example of tone curves set for respective regions by the gradation correction processing S7A. In the graph of FIG. 11, a horizontal axis indicates an input value corresponding to a pixel value before gradation correction, and a vertical axis indicates an output value corresponding to a pixel value after gradation correction. In the example of FIG. 11, the input value and the output value are normalized and take values from 0 to 1. The input value and the output value are not limited thereto, and may be set using, for example, gradation values from 0 to 255.

In FIG. 11, a reference tone curve indicating a reference (for example, an initial value) is shown by a solid line, a tone curve set (corrected) for the self-luminous region is shown by a dotted line, and a tone curve set (corrected) for the ambient-light region is shown by a dashed line.

The gradation correction of the present embodiment includes tone curve correction as described above. In addition, or alternatively, the gradation correction may include gamma correction.

As described above, in the present embodiment, a user operation sets image quality of the self-luminous region and the ambient-light region in the image data by adjusting gradation of the ROI. As a result, gradation of a region selected by a user operation from the ambient-light region and the self-luminous region can be adjusted independently of a non-ROI region, making it possible to capture an image having natural color tones or color tones that match user preferences.

### 3. Third Embodiment

### 3-1. Exposure Correction Amount Setting

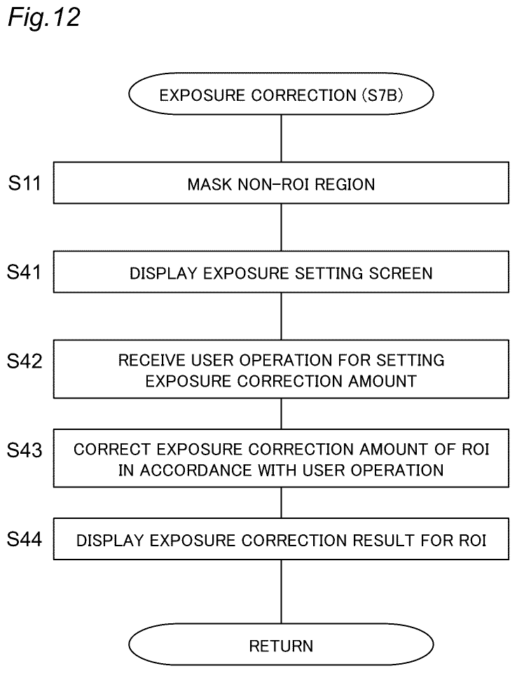

In the third embodiment, an example in which exposure correction processing is performed as the image quality setting will be described. That is, in the third embodiment, the controller 135 executes the processing of S1 to S6 in FIG. 4 in the same manner as in the first embodiment, and executes exposure correction processing S7B shown in FIG. 12 instead of the WB setting S7 of FIG. 4.

FIG. 12 is a flowchart illustrating exposure correction S7B. In FIG. 12, first, the controller 135 performs mask processing that lowers visibility of a non-ROI region relative to an ROI (S11). The mask processing in the present embodiment is the same as the mask processing of the first embodiment shown in FIG. 5.

The controller 135 causes the display monitor 130 to display an exposure setting screen (S41), and receives, via the operation member 150, an input of a user operation for setting an exposure correction amount (S42). In accordance with the received user operation, the controller 135 determines an exposure correction amount for the ROI (S43). The controller 135 causes the display monitor 130 to display a captured image after exposure correction (S44).

The exposure correction amount is defined, for example, by an EV (exposure value). The EV is adjustable, for example, within a range from −5 EV to +5 EV in increments of ⅓ EV. Proper exposure may also be represented using an EV.

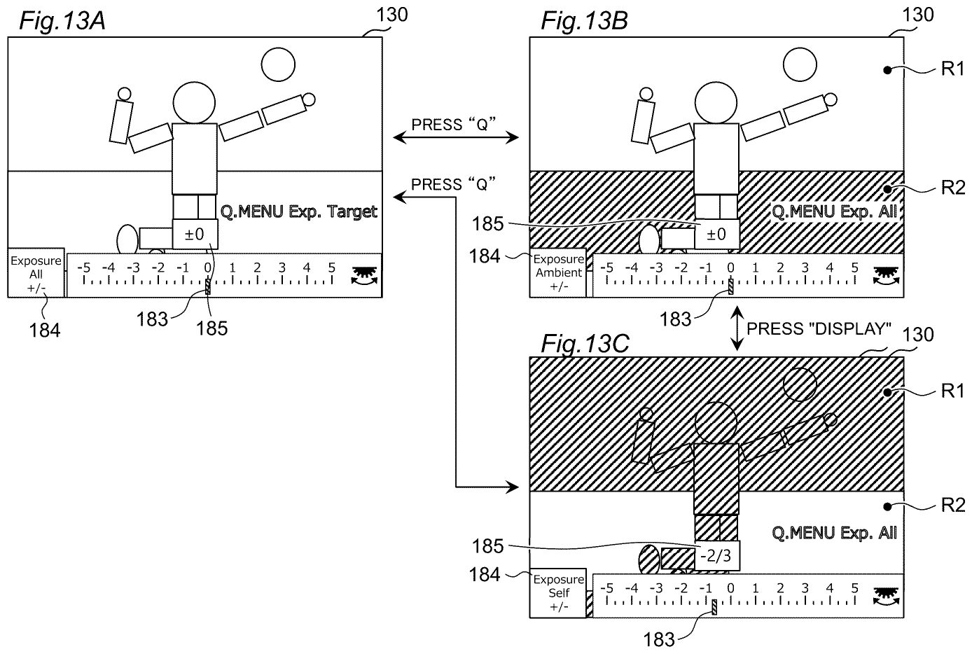

FIGS. 13A, 13B and 13C are a diagram illustrating an exposure setting screen. The exposure setting screen is superimposed on a region selection screen. As in the region selection screen of the first embodiment shown in FIG. 6, in the exposure setting screen of FIGS. 13A, 13B and/or 13C, the user can input a user operation for selecting a self-luminous region or an ambient-light region by using the Q button 156 and the DISP button 157.

When shooting is performed, a through image is displayed on the display monitor 130, as shown in FIG. 13A. In the exposure setting screen illustrated in FIG. 13A, exposure correction can be performed for an entire image.

When the Q button 156 is pressed while the screen shown in FIG. 13A is displayed, the controller 135 transitions the screen to a per-region exposure setting screen shown in FIG. 13B or FIG. 13C.

FIG. 13B shows an exposure setting screen in a state where the ambient-light region R1 is selected. As in the first embodiment, mask processing lowers visibility of the self-luminous region R2 relative to the ambient-light region R1. The exposure setting screen shown in FIG. 13B displays a ROI indicator 184 indicating that the screen is used to correct an exposure of the ambient-light region R1.

When the DISP button 157 is pressed while the exposure setting screen shown in FIG. 13B is displayed, the screen transitions to the exposure setting screen shown in FIG. 13C. In this manner, the exposure setting screens of FIG. 13B and FIG. 13C can be switched from one to the other by using the DISP button 157.

In the exposure setting screens of FIGS. 13A to 13C, a user can set a correction amount by using a slide bar 183. The slide bar 183 is movable, for example, in response to a user operation on the dial 154, the cursor button 152, or the like. The correction amount is displayed in a correction amount display window 185.

### 3-2. Application of Exposure Correction Amount

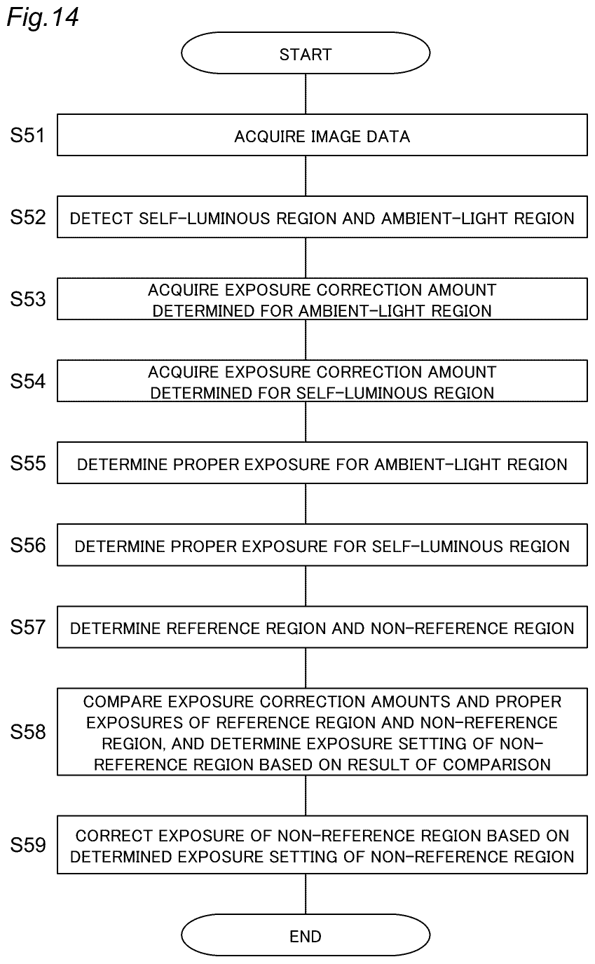

With reference to FIG. 14, an operation of applying correction to a captured image in accordance with the exposure correction amount set in the processing of FIG. 12 will be described. The flow of FIG. 14 is repeatedly executed, for example, at a predetermined frame cycle.

In FIG. 14, first, the controller 135 controls an imaging operation of the image sensor 115 to acquire image data (S51). The image processor 120 detects a self-luminous region and an ambient-light region in an image indicated by the acquired image data (S52).

The controller 135 acquires exposure correction amounts respectively determined for the ambient-light region and the self-luminous region (S53, S54). The exposure correction amounts are determined in step S43 of FIG. 12.

The controller 135 determines proper exposure for each of the ambient-light region and the self-luminous region (S55, S56). The proper exposure includes, for example, a parameter that makes an exposure amount in the corresponding region of the image proper. In the present embodiment, the proper exposure may be standard exposure calculated by a known technique. The proper exposure may be defined by an EV. The EV is defined by an aperture value (F-number), shutter speed, ISO sensitivity, and the like. The exposure amount in the image may include luminance, gain, and the like.

The controller 135 determines one of the ambient-light region and the self-luminous region as a reference region based on the proper exposures of the ambient-light region and the self-luminous region calculated in steps S55 and S56, respectively (S57). A region that is not the reference region among the ambient-light region and the self-luminous region is defined as a non-reference region. For example, the controller 135 compares proper exposure EV1 of the ambient-light region with proper exposure EV2 of the self-luminous region, and determines, as the reference region, a region corresponding to proper exposure that would result in a darker output image when the same light is captured.

Next, the controller 135 compares the exposure correction amounts and the proper exposures of the reference region and the non-reference region, determines exposure setting of the non-reference region based on a result of the comparison (S58), and corrects exposure of the non-reference region based on the determined exposure setting of the non-reference region (S59).

An example of the exposure setting of the non-reference region in step S58 will be described. First, a case in which there is no difference between the proper exposures of the ambient-light region and the self-luminous region determined in steps S55 and S56 will be described. For example, when the reference region is the self-luminous region, the exposure correction amount of the self-luminous region determined in step S43 is −⅔ EV, and the exposure correction amount of the ambient-light region is 0 EV, a difference between the exposure correction amount of the reference region and the exposure correction amount of the non-reference region is ⅔ EV. Accordingly, when a certain scene is captured, an exposure amount or gain that is insufficient in the non-reference region as compared with the reference region corresponds to ⅔ EV. In step S59, after setting an exposure amount of an entire screen to an exposure amount of the reference region, exposure of the non-reference region is corrected by increasing the exposure amount or the gain that is insufficient in the non-reference region. For example, after setting the exposure amount of the entire screen to the exposure amount of the reference region, exposure of the non-reference region is corrected by increasing ISO sensitivity of the non-reference region.

That is, in this example, when an image is divided into the ambient-light region and the self-luminous region, and proper exposure settings obtained by automatic exposure (AE) processing for the respective regions are the same, if a user sets the exposure correction amount of the self-luminous region to −⅔ EV, ISO sensitivity of the non-reference region is increased. Even when aperture value (F-number) or shutter speed in exposure control can be set only uniformly over the entire screen, ISO sensitivity (gain) can sometimes be changed for each region. When ISO sensitivity corresponding to a region in which an output image becomes darker when the same light is captured is at a lower limit, it is not possible to correct exposure to darken an image for that region; therefore, as described above, a region corresponding to proper exposure that results in a darker output image when the same light is captured is set as the reference region. Correction is performed so that, after matching an exposure amount of the entire screen to that of the reference region (the self-luminous region in the above example), the non-reference region is brightened by an amount corresponding to a difference (⅔ EV in the above example).

On the other hand, when there is a difference between the proper exposures of the ambient-light region and the self-luminous region, the exposure setting of the non-reference region is determined further based on a difference between the proper exposure of the reference region and the proper exposure of the non-reference region, in addition to the difference between the exposure correction amount of the reference region and the exposure correction amount of the non-reference region illustrated above. A case in which there is a difference between the proper exposures of the ambient-light region and the self-luminous region includes, for example, a case in which there is a difference in aperture value (F-number), shutter speed, ISO sensitivity, or the like between the ambient-light region and the self-luminous region.

### 3-3. Effects

As described above, in the present embodiment, a user operation sets image quality by correcting exposure related to an exposure amount in the selected region. As a result, exposure of a region selected by a user operation from the ambient-light region and the self-luminous region can be adjusted independently of a non-ROI region, making it possible to capture an image having natural color tones or color tones that match user preferences.

### 4. Other Embodiments

As described above, the embodiments have been described as examples of the technology in the present disclosure. However, the technology in the present disclosure is not limited thereto, and can also be applied to embodiments in which changes, substitutions, additions, omissions, and the like, are appropriately made. In addition, it is also possible to combine the components described in the above embodiments to form a new embodiment. Thus, other embodiments will be exemplified below.

In the first embodiment, an example has been described in which the image processor 120 executes region segmentation processing (S2) for detecting a self-luminous region and an ambient-light region. The digital camera 100 may be configured such that, after the region segmentation processing by the image processor 120, a user can modify the region segmentation by using the operation member 150. For example, the user can change a part of a region detected as a self-luminous region to an ambient-light region by using the operation member 150. As a result, the self-luminous region and the ambient-light region can be set more accurately in the image.

In addition, the controller 135 may be capable of setting, as either an ambient-light region or a self-luminous region, a region that has been determined by the image processor 120 as not corresponding to either the self-luminous region or the ambient-light region, in accordance with a user operation received via the operation member 150.

In the first embodiment, an example has been described in which the region segmentation processing is executed by the controller 135 or the image processor 120 of the digital camera 100. However, the present disclosure is not limited thereto. For example, the region segmentation processing may be executed by an information processing apparatus, such as a server device, that receives image data from the digital camera 100 via a network, and the information processing apparatus may transmit image data after region segmentation to the digital camera 100.

In the embodiments described above, an example has been described in which image quality adjustment (see, for example, S23 and S24 of FIG. 8 and S59 of FIG. 14) is performed in real time during shooting. However, the present disclosure is not limited thereto. For example, image data may be recorded in the flash memory 145 or the memory card 142, and the controller 135 may perform image quality adjustment processing on the recorded image data in a non-real-time manner after shooting.

In addition, the image quality adjustment processing of the present disclosure does not need to be executed by the controller 135 or the image processor 120 of the digital camera 100, and may be executed by an information processing apparatus, such as a server device, that receives image data from the digital camera 100 via a network.

### 5. Example of Aspects

Hereinafter, various aspects according to the present disclosure will be listed.

Aspect 1 according to the present disclosure provides an imaging apparatus including:
an image sensor that captures a subject image to generate image data;
a controller that detects a first region corresponding to a light-emitting body and a second region corresponding to a subject different from the light-emitting body in an image indicated by the image data; and
a user interface that receives a first user operation that selects the first region or the second region in the image, wherein
the controller
   receives a second user operation that sets image quality of the selected region via the user interface; and
   adjusts image quality of the first region and the second region in the image data in accordance with a result of the setting.

Aspect 2 provides the imaging apparatus according to Aspect 1, wherein the second user operation sets the image quality by adjusting white balance of the selected region.

Aspect 3 provides the imaging apparatus according to Aspect 1 or 2, wherein the second user operation sets the image quality by adjusting gradation of the selected region.

Aspect 4 provides the imaging apparatus according to any one of Aspects 1 to 3, wherein the second user operation sets the image quality by correcting exposure related to an exposure amount in the selected region.

Aspect 5 provides the imaging apparatus according to any one of Aspects 1 to 4, further including a display that displays the image, wherein
the controller causes the display to display the first region and the second region, and receives the first user operation via the user interface.

Aspect 6 provides the imaging apparatus according to Aspect 5, wherein the controller causes the display to display the selected region in a first display appearance, and causes the display to display a non-selected region not selected from the first region and the second region in a second display appearance different from the first display appearance.

Aspect 7 provides the imaging apparatus according to Aspect 6, wherein the first display appearance of the selected region has higher visibility than the second display appearance of the non-selected region.

Aspect 8 provides an image processing method executed by a controller of an imaging apparatus, the method including:
acquiring image data generated by capturing a subject image;
detecting a first region corresponding to a light-emitting body and a second region corresponding to a subject different from the light-emitting body in an image indicated by the image data;
receiving an input of a first user operation that selects the first region or the second region in the image;
receiving a second user operation that sets image quality of the selected region; and
adjusting image quality of the first region and the second region in the image data in accordance with a result of the setting.

Aspect 9 provides a non-transitory computer-readable storage medium storing a program for causing a processor to execute the image processing method according to Aspect 8.

1. An imaging apparatus comprising:
an image sensor that captures a subject image to generate image data;
a controller that detects a first region corresponding to a light-emitting body and a second region corresponding to a subject different from the light-emitting body in an image indicated by the image data; and
a user interface that receives a first user operation that selects the first region or the second region in the image, wherein
the controller
receives a second user operation that sets image quality of the selected region via the user interface; and
adjusts image quality of the first region and the second region in the image data in accordance with a result of the setting.

2. The imaging apparatus according to claim 1, wherein the second user operation sets the image quality by adjusting white balance of the selected region.

3. The imaging apparatus according to claim 1, wherein the second user operation sets the image quality by adjusting gradation of the selected region.

4. The imaging apparatus according to claim 1, wherein the second user operation sets the image quality by correcting exposure related to an exposure amount in the selected region.

5. The imaging apparatus according to claim 1, further comprising a display that displays the image, wherein
the controller causes the display to display the first region and the second region, and receives the first user operation via the user interface.

6. The imaging apparatus according to claim 5, wherein the controller causes the display to display the selected region in a first display appearance, and causes the display to display a non-selected region not selected from the first region and the second region in a second display appearance different from the first display appearance.

7. The imaging apparatus according to claim 6, wherein the first display appearance of the selected region has higher visibility than the second display appearance of the non-selected region.

8. An image processing method executed by a controller of an imaging apparatus, the method comprising:
acquiring image data generated by capturing a subject image;
detecting a first region corresponding to a light-emitting body and a second region corresponding to a subject different from the light-emitting body in an image indicated by the image data;
receiving an input of a first user operation that selects the first region or the second region in the image;
receiving a second user operation that sets image quality of the selected region; and
adjusting image quality of the first region and the second region in the image data in accordance with a result of the setting.

9. A non-transitory computer-readable storage medium storing a program for causing a processor to execute the image processing method according to claim 8.
